(19) United States
(12) Patent Application Publication
(10) Pub. No.: US 2006/0098312 A1
(43) Pub. Date: May 11, 2006

(54) Optical device

(76) Inventor: Patrik Borg, Vasteras (SE)

Correspondence Address: Robert S Smith;Law Offices of Robert S Smith, 1131-0 Tolland Turnpike, Suite 306, Manchester, CT, 06040, US

(21) Appl. No.: 10/535,758

(22) PCT Filed: Nov. 3, 2003
(86) PCT No.: PCT/SE03/01689

§ 371 Date: May 19, 2005

(30) Foreign Application Priority Data
Nov. 28, 2002 (SE) 0203511-1

(51) Int. Cl. G02B 7/182

(52) U.S. Cl. 359/862

(57) ABSTRACT

A device making it possible for a person to see an object located below his eyes with his eves directed substantially forward, comprising a first and a second mirror arranged such that they render an optical path reaching from the object towards one reflective surface of the first mirror, then further to a reflective surface of the second mirror, and then to the eyes. The device comprises a framework and is arranged to, at positioning of the framework and the mirrors in front of and at a distance from the body of a person having his upper part of his body substantially upright, holding his hands in a position in front of the upper part of his body, and having his eyes directed substantially forward, show the hands of the person.

### TECHNICAL FIELD AND PRIOR ART

The present invention relates to a device making it possible for a person to see an object located below his eyes with his eyes directed substantially forward. The device comprises a first and a second mirror arranged such that they render an optical path reaching from the object towards a reflective surface of the first mirror, then further to a reflective surface of the second mirror, and then to the eyes.

Biologically and anatomically, the human being is since immemorial times built to be a wanderer and to be able to see far. The neck is thus best suited for an upright position with the eyes directed substantially forward. The shoulders are, in turn, best suited for having the arms hanging down next to the body and not constituting any levers loading the shoulders. When a person works with his hands, the hands must, however, be put together in front of the body. The most suitable ergonomics for the shoulders is obtained if the hands are kept as close to the body as possible with the upper arms along the body.

Many situations in daily life demand that work is carried out with the hands at the same time as the eyes must be able to see the hands. This can be carried out in two ways. One way is that the work is carried out in front of the stomach. This working method saves the shoulders, but loads the neck, which must be bent downwards in order for one to see one's hands. The second way is that the work is carried out in level with the eyes. This working method saves the neck, but loads the shoulders instead. Often, the work is constituted of working in an intermediate position between these two, which leads to loading of both neck and shoulders. A healthy person can work like this for short periods without having any troubles. It is problematic, however, for persons who must work in this position for a long time, for example during mounting work, soldering, sewing, punching. This type of working position is also present in the home, for example when doing the dishes, handy work, reading, and writing. This is also an especially bad problem for persons suffering from neck damages, for example whiplash or rheumatism, and thus experiencing problems when having a bent neck and/or increased load. The problem could be solved with one mirror, but then the picture would be the wrong way around and upside down.

One solution of this problem is described in the American patent No. U.S. Pat. No. 5,422,759, in which two mirrors are used to reflect the picture back again. In this document, an optical apparatus is shown intended to be carried in front of the eyes. This apparatus makes it possible for the carrier to look down at the same time as the head is straight and the eyes look straight forward. For this purpose, two mirrors are used. The first mirror is arranged close to the face and just below the horizontal line from the eyes. The second mirror is arranged further away from the face and above the horizontal line of the eyes. The mirrors are mounted on a pair of glasses. One drawback with such a device is that it can be experienced as uncomfortable and that it is obstructing during working. Further drawbacks are that the glasses are not steady and that the mirrors limit the natural field of vision for the user considerably. Since different persons have different sizes of heads, the glasses must be manufactured in several different sizes in order to fit everyone. Several persons cannot use a certain pair of glasses, but every person must have his own piece being adapted for that person in particular.

In an American patent with No. U.S. Pat. No. 6,059,417, a device is shown making it possible for a person lying in a bed to look up into the ceiling and at the same time watch TV, when the TV is arranged in front of the bed. This device also comprises two mirrors arranged to reflect the picture from the TV to the eyes of the person lying in the bed. This device is either mounted in the ceiling or on the wall above the person lying in the bed.

### PURPOSE AND SUMMARY OF THE INVENTION

The purpose with the present invention is to provide a device making it possible to work in an ergonomically correct way for both the neck and the shoulders at the same time and yet to be able to see ones working hands. Further, the device is to be simple to use and manufacture and simple to adjust such that an optimal function is achieved. This purpose is achieved with the device indicated in the introduction, being characterised in that the device comprises a framework and is designed to, at positioning of the framework and the mirrors in front of and at a distance from the body of a person having his upper part of the body substantially upright, holding his hands in a position in front of the upper part of the body, and having his eyes directed substantially forward, show the hands of a person.

With such a device it is possible to see one's working hands at the same time as one looks forward and works with the hands in front of the stomach in an unloaded position for both the neck and the shoulders. The device is especially useful for a person sitting down or standing up, having his upper part of his body substantially upright. To position the device in front of and at a distance from the user, instead of upon the person, is advantageous, since the device becomes steadier. The person can feel free to leave the working place without having to remove the device and several different persons can use the same device thanks to the fact that it can be adjusted such that it fits everyone. The expression that the eyes are directed substantially forward also includes that the look can be directed obliquely downwards, provided that the head is kept upright and the neck is straight. The characteristic that the framework is to be designed for positioning in front of and at a distance from a person using the device does not mean that the whole framework must be positioned in such a way, but only that the part of the framework carrying the mirrors are to have such a position. Other parts of the framework may extend at the side of and/or behind and/or above the person.

According to a preferred embodiment of the invention, the mirrors are arranged vertically adjustable in relation to the framework. Advantageously, the mirrors are also arranged vertically adjustable in relation to each other. According to a further preferred embodiment of the invention, each of the mirrors are arranged adjustable to different angular positions relative to the framework and thus relative to a person being in a fixed position. Advantageously, the mirrors are arranged such that the distance between them is adjustable. In order to obtain the best possible function and ergonomics, a correct adjustment of the mirrors is important. All these different ways of adjusting the mirrors make it possible to adjust the device for different situations and/or different persons.

According to a further preferred embodiment of the invention, it comprises a holding member arranged to hold the mirrors and the holding member is arranged connected with the framework. The holding member is arranged vertically displaceable relative to the framework. Such a displacement movement can in a simple way be achieved by the framework being provided with longitudinal grooves for the displacement movement, extending substantially in a vertical direction.

According to a further preferred embodiment of the invention, the holding member is arranged rotatable in relation to the framework around an axis of rotation and the mirrors are arranged on opposite sides of said axis, such that when rotating in one direction around said axis, the first mirror is raised as the second mirror is lowered, and when rotating in the other direction around said axis, the first mirror is lowered as the second mirror is raised, wherein the mirrors are vertically adjustable in relation to each other by rotating the holding member.

Advantageously, the device comprises a locking member arranged to lock the axis of rotation and thus to lock the angular position of the holding member relative to the framework. In one embodiment, the locking member is also arranged to lock the vertical displacement of the holding member and thus at the same time to lock the position and the angular position of the holding member relative to the framework. One such arrangement makes it possible to lock the vertical positions of both the mirrors with one single manipulation. Advantageously, this is achieved by the axis of rotation for the holding member being arranged to coincide with said groove, wherein the axis of rotation is displaceable along the groove.

According to a further preferred embodiment of the invention, the distance between the mirrors is adjustable by at least one of the mirrors being arranged displaceable relative to the holding member. Advantageously, this mirror is also arranged rotatable in relation to the holding member around an axis of rotation.

According to a further preferred embodiment of the invention, the device comprises a locking element arranged to lock the angular position of the mirror relative to the holding member and the locking element is also arranged to lock the displacement of the mirror relative to the holding member and thus at the same time lock both the position and angular position of the mirror relative to the holding member. Such an arrangement makes it possible to lock both the angular position of the mirror and its distance to the second mirror by one single manipulation. Advantageously, this is achieved by the holding member being provided with a longitudinal groove for the displacement movement of the mirror relative to the second mirror, wherein the axis of rotation of the mirror is displaceable along the groove.

According to a further preferred embodiment of the invention, the mirrors are arranged detachable from the holding member. Thanks to the mirrors being detachable from the holding member, they can easily be dismounted for cleaning or to be changed.

According to a further preferred embodiment of the invention, the first mirror is a confrontation mirror arranged such that it is possible to see through the mirror. It is advantageous, if one sometimes wants to be able to look directly on the hands and not only to see them through the mirrors.

A further object of the invention is to indicate a method making it possible for a person having his upper part of his body substantially upright and holding his hands in a position in front of his upper body, to see his hands with his eyes directed substantially forward. This object is achieved with a method comprising positioning a first and a second mirror at a distance from and in front of the upper part of the body in such a way that an optical path is obtained reaching from the hands towards a reflective surface of the first mirror, then further to a reflective surface of the second mirror, and then to the eyes.

### BRIEF DESCRIPTION OF THE DRAWINGS

FIG. 1 shows the optical principle for a device according to the invention.

FIG. 2a shows a perspective view of a device according to a first embodiment of the invention

FIG. 2b shows a mirror holder, which constitutes a part of the device shown in FIG. 2a.

FIG. 3 shows the device in FIG. 2a as seen from the side, in one embodiment intended for hanging onto a wall.

FIG. 4 shows the device in FIG. 2a as seen from the side, in one embodiment intended for positioning on a table or on a bench.

FIG. 5 shows the device in FIG. 2a as seen from the side, in one embodiment intended for hanging from above.

FIG. 6a shows a second embodiment of the invention as seen straight from the front.

FIGS. 6b and 6c shows the device in FIG. 5a as seen from the side in one folded out and in one folded situation.

### DETAILED DESCRIPTION OF PREFERRED EMBODIMENTS

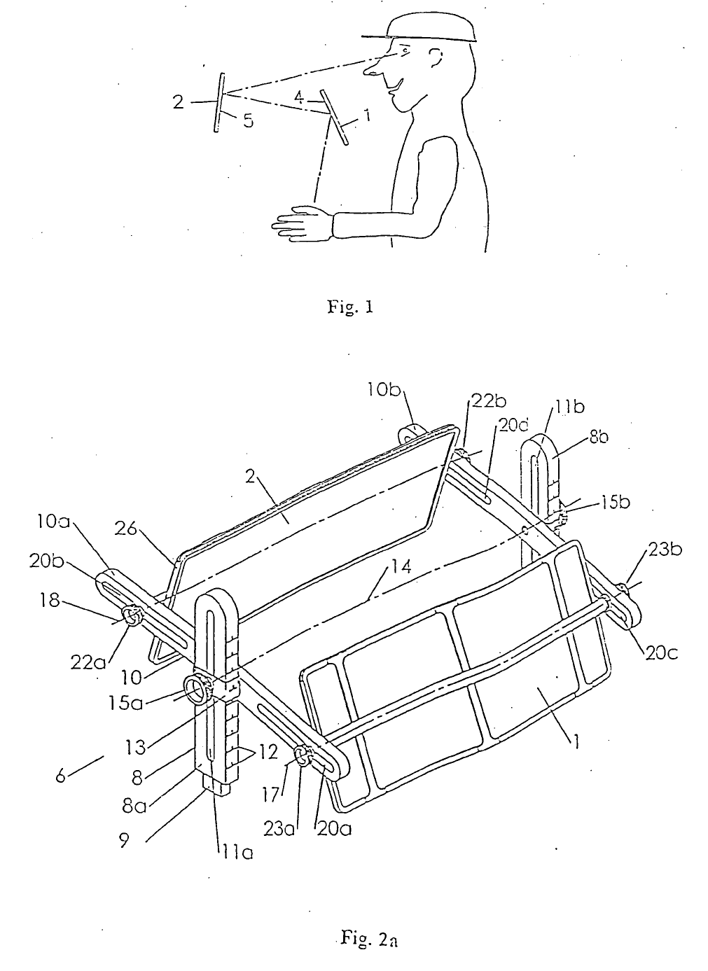

FIG. 1 shows a person having his upper part of his body substantially upright and holding his hands in a position in front of his upper part of his body. The person in question may either be standing up or be seated. The person holds his head straight and directs his gaze substantially forward. In front of the person and at a distance from him is a first mirror 1 and a second mirror 2 arranged such that they render an optical path reaching from the hands towards one reflective surface 4 of the first mirror, then further to a reflective surface 5 of the second mirror 2, and then to the eyes. The second mirror 2 has its reflective surface 5 turned partly towards the eyes of the person and partly towards the reflective surface 4 of the first mirror. The first mirror 1 has the reflective surface 4 turned partly towards the hands and partly towards the reflective surface 5 of the second mirror. The mirrors are arranged at a distance from each other. The second mirror 2 is arranged farther away from the body of the person and the first mirror 1 is arranged closer to the body of the person. The mirrors 1 and 2 are arranged such that the person may see his working hands without the picture being reversed, at the same time as his head is held upright in an unloaded position for both the neck and the shoulders.

FIG. 2a shows a first embodiment of the device according to the invention. The mirrors 1, 2 are suspended on a stand 6. The stand 6 comprises a framework 8 and a holding member 10 arranged to hold the mirrors 1, 2. The framework is designed for being positioned in front of and at a distance from a user and for positioning in the vicinity of the hands of the user. The framework comprises two longitudinal, substantially parallel supporting members 8a, 8b arranged at a distance from each other. The supporting members 8a, 8b are essentially vertically arranged and are in their lower ends provided with an attachment member 9 for detachable attachment against a base stand. The design of the base stand depends on the application in which the device is to be used. In this example, the attachment members 9 are in the form of a male and the base stand is provided with a female, but the attachment member may, of course, be formed in many other ways.

The holding member 10 is arranged vertically displaceable relative to the framework 8. For this purpose, the supporting members 8a, 8b are provided with longitudinal, vertical grooves 11a, 11b, and the holding member 10 is arranged displaceable along the grooves 11a, 11b. The length of the grooves 11a, 11b decides how long the mirrors can be adjusted vertically. On one side of the supporting members 8a, 8b there are markings 12 in the form of numbered lines. Further, the supporting members 8a, 8b are each provided with a transparent plastic sleeve 13, which follows the displacement movement of the holding member 10 and marks the height of the holding member in relation to the markings 12. In such a way, the adjustment of the height of the holding member is facilitated such that both sides of the mirrors can be adjusted to the same height.

The holding member 10 is arranged rotatable in relation to the framework 8 around a axis of rotation 14 which is substantially horizontal and reaches through the grooves 11a, 11b. The grooves 11a, 11b are in this embodiment example through-going. The holding member 10 comprises two longitudinal holding elements 10a, 10b. The holding element 10a is arranged rotatably connected with the supporting member 8a and the holding element 10b is arranged rotatably connected with the supporting member 8b. The holding elements 10a, 10b are substantially parallel and extend outwardly on each side of the supporting members. Each of the holdings members 10a, 10b are in this embodiment example a longitudinal rod comprising a middle part being rotatably connected with the supporting member around the axis 14, a first end extending in a direction outwardly from the framework and a second end extending in the opposite direction out from the framework. The mirrors 1,2 are arranged between the holding elements on opposite sides of the axis 14. The holding elements carry in their first end the first mirror 1 and in their other end the second mirror 2. The mirrors are thus arranged vertically adjustable relative to each other by turning the holding member 10 around the axis 14. When the holding member is turned in one direction, the first mirror is raised and the other mirror is lowered and when the holding member is turned in the second direction, the second mirror is raised and the first mirror is lowered.

The device comprises locking members 15a, 15b arranged to lock the axis of rotation 14 of the holding member 10 and thus to lock the angular position relative to the framework 8. The locking members 15a, 15b are arranged such that they lock the angular position of the holding member relative to the framework at the same time as they also lock the position of the holding member in the grooves 11a, 11b and thus the vertical position of the holding member. In this embodiment example, the locking member 15a, 15b is a wheel with a longitudinal part provided with screw threads arranged to engage corresponding screw threads of the holding element 10. The locking member 15a is located on the outside of the supporting member 8a and the longitudinal part of the locking member 15a extends through the groove 11a and engages the screw-threads of the holding element 10a. The corresponding is valid for the locking member 15b.

The mirrors 1, 2 are adjustable into different angular positions relative the holding member 10 by each being rotatably connected with its holding element 10a, 10b around its axis 17, 18. The mirrors 1, 2 are also arranged such that the distance between them is adjustable. For this purpose, the holding elements 10a, 10b are provided with longitudinal grooves 20a-20d and the mirrors are arranged displaceable along the grooves. The first mirror 1 is arranged such that the axis of rotation 17 extends through the grooves 20a, 20c, and the second mirror 2 is arranged such that the axis of rotation 18 extends through the grooves 20b, 20d. The mirrors are thus displaceable along the grooves 20a-20d and thus also relative to each other.

The mirrors 1, 2 are displaceable along the holding member and displaceable along the axis 17, 18. The device is provided with locking elements 22a, 22b, 23a, 23b arranged to lock the angular positions of the mirrors relative to the holding member 10 and at the same time lock the displacement of the mirrors relative to the holding member. The locking elements 22a, 22b, 23a, 23b are in this embodiment example wheels provided with screw-threads intended to engage corresponding screw-threads in the mirror. The locking elements 22a, 22b, 23a, 23b are arranged in connection with the grooves 20a-20d.

Each of the mirrors 1, 2 are arranged in mirror holders 26. FIG. 2a shows in greater detail how a mirror holder 26 can be designed. The mirror holder 26 is designed such that the mirror 1 is detachable from the mirror holder. The mirror holder has a front side in the form of a frame and a backside supporting the mirror. The mirror holder is provided with an opening making it possible to insert and pull out the mirror. The mirror shown in FIG. 2b is partly inserted in the mirror holder 26.

In this embodiment example, the first mirror 1 is a confrontation mirror, which is arranged such that it is possible to see straight through the mirror from one side at the same time as the other side of the mirror reflects the incident light. The mirrors are preferably surface foiled in order to prevent double pictures. With surface foiled is intended that the reflective layer is arranged directly on the front side of the mirror. It is also possible to use ordinary mirrors. The mirror has a height varying between 10 and 30 centimetres, for example around 20 centimetres. The width of the mirrors can vary depending on desire but is usually about 30-35 centimetres, but can vary from 10 centimetres and upwards. The second mirror, which is positioned farther away from the person than the first mirror is preferably somewhat smaller than the first mirror. In this embodiment example, both the first and the second mirror are planar, but in an alternative embodiment they may be slightly concave in order to achieve a certain magnification effect.

In one starting position, both mirrors are adjusted perpendicular towards the holding elements. The mirrors are then adjusted into a desired position. For the second mirror a suitable adjustment of the angular position may vary from between 30 and −45° and for the first mirror a suitable adjustment of the angular position may vary between −10 and −70°, for example −30°. The holding elements 10a, 10b can be in the order of 10-35 centimetres high and about 5 centimetres wide. The grooves 11a, 11b may vary between 0 and 30 centimetres. The supporting members 8a, 8b are usually vertically arranged but can also be arranged in other directions depending on the design of the stand. The holding elements can, for example, extend in the order of between 20 and 25 centimetres in each direction. The grooves 20a-20d in the holding elements are preferably designed such that the distance between the mirrors can be varied between 10 and 35 centimetres.

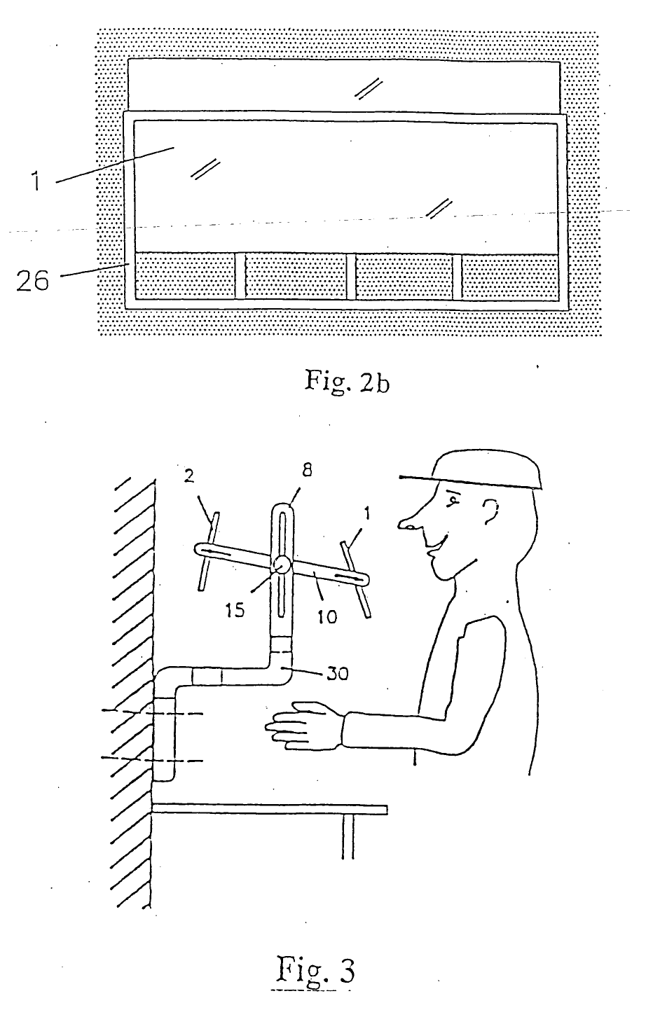

FIG. 3 shows the device in FIG. 2a in one embodiment intended to be hung on a wall. The device comprises a base stand 30 designed to be mounted on a wall. One end of the base stand is designed to be attached against the wall and the other end is arranged to carry the framework with the mirrors and comprises an attachment member fitting to a corresponding attachment member of the framework 8. In its embodiment hung on a wall, the device can, for example, be positioned above a kitchen sink or above a workbench in order to make it possible for a person to see his hands when he is performing work at the bench.

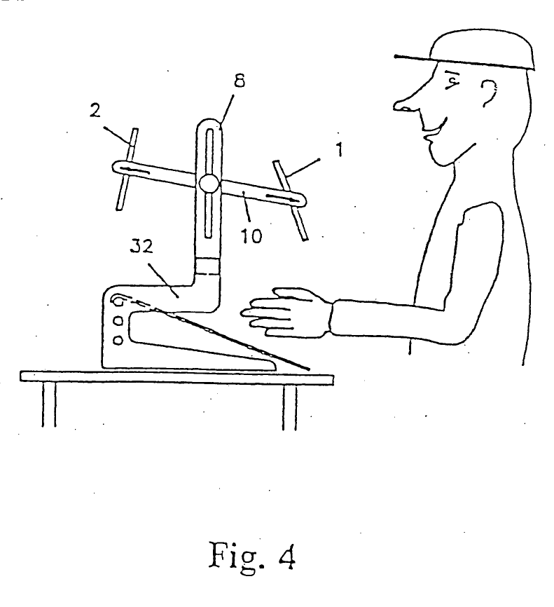

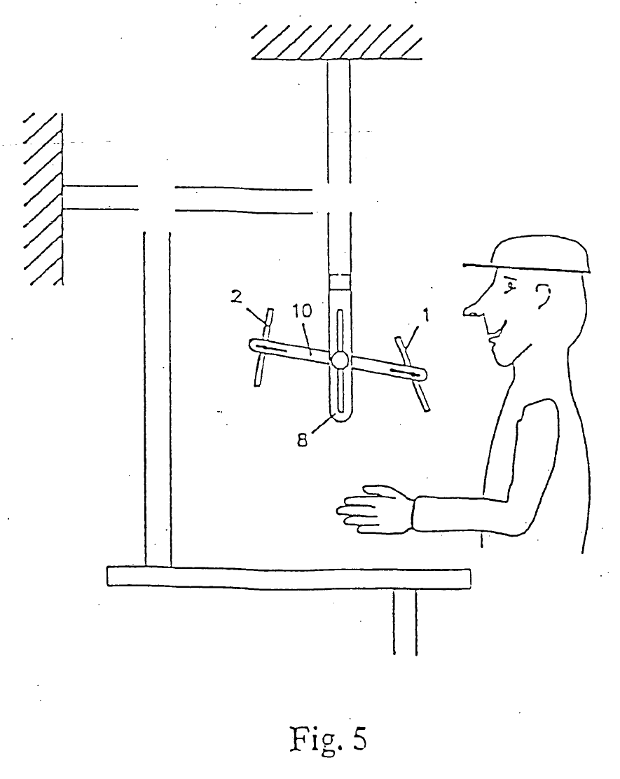

FIG. 4 shows an alternative embodiment of the device intended for positioning on a table or something similar. The device comprises a base stand 32, one end of which is designed to be put on a planar surface and its other end is provided with attachment members arranged to attach the base stand against the framework 8. A slanting plate 34 is arranged on the base stand. The angle of the plate can, for example, be varied between 10° and 45° relative to the table. This table variant can, for example, be used for writing, reading, and sewing. It can also be put, without a plate, in front of a screen, above a keyboard in order to attain the correct angle for the neck during terminal work.

During the use of a device according to the invention, a person sits or stands in front of and at a distance from the device. Thereafter, the position of the mirrors in the vertical direction, the angular position, and the distance between the mirrors are adjusted such that the person may see his hands at the same time as the head is upright and the gaze is directed substantially straight forward. The positionings are to be made such that it feels comfortable to work and such that the hands are clearly visible when the person looks into the back mirror.

FIG. 5 shows an alternative embodiment of the invention intended for hanging in a base stand in the form of an arm which, in turn, is attached to a ceiling, on a wall, on a table, or on a stand on the floor.

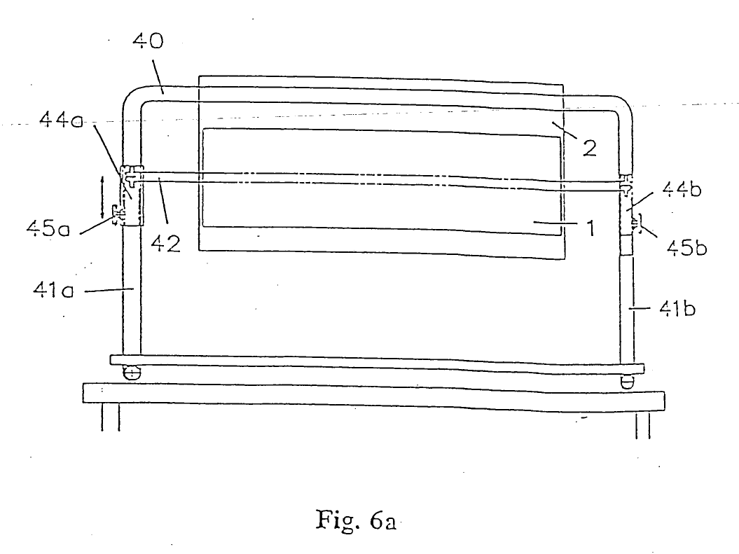

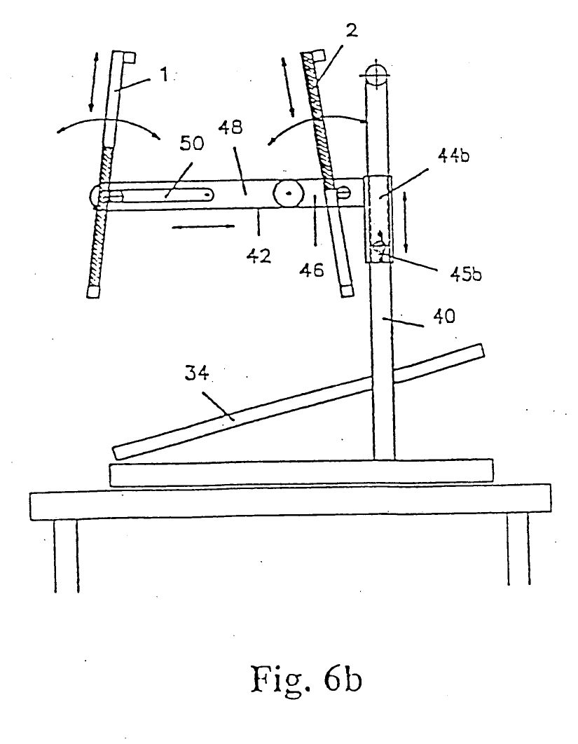

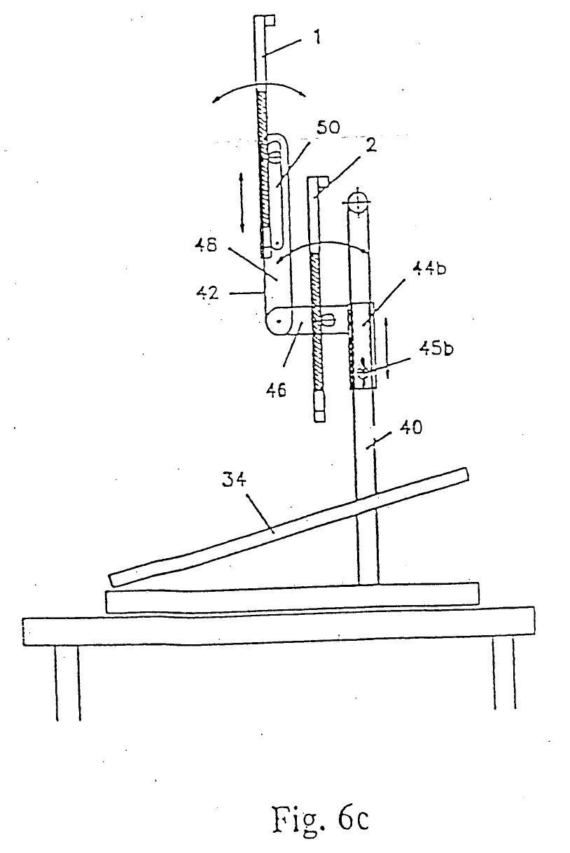

In an alternative embodiment, the device is designed foldable, so that it easily may be put away and/or transported. The FIGS. 6a-6c show a second embodiment of the device according to the invention. The device comprises a U-shaped framework 40 designed to be positioned on, for example, a table. The framework 40 comprises two essentially vertical, parallel shanks 41a, 41b. A holding member 42 sits on the framework holding two mirrors 1,2. The holding member 42 is vertically displaceably connected with the framework 40. The holding member 42 comprises two sleeves 44a, 44b threaded on the shanks 41a and 41b in such a way that the sleeves are vertically displaceable relative to the shanks. The device comprises locking members 45a, 45b in order to lock the position of the holding member relative to the framework.

Between the sleeves 44a, 44b an essentially U-shaped arm extends, which is divided into an inner part 46 and an outer part 48. The inner part of the arm 46 holds the second mirror 2 and the outer part of the arm 48 holds the first mirror 1. The outer part of the arm 48 is arranged rotatable in relation to the inner part of the arm 46 in such a way that the holding member becomes foldable. This is advantageous, since the device occupies less space when not in use or when it is to be transported. The outer part 48 of the arm is provided with a longitudinal groove 50 and the first mirror 1 is arranged such that it is displaceable along the groove 50. The mirror 1 is also arranged rotatable in relation to the holding member in such a way that different angular positions may be selected. The second mirror 2 is also arranged rotatable in relation to the holding member 42 in such a way that different angular positions may be selected. Thus, the angular positions of both mirrors relative to the framework may be selected independent of each other. The device can also comprise a slanted plate 34, on which the hands may rest during the work.

The invention is not limited to the embodiments shown but can be varied and modified within the framework of the following claims. In an alternative embodiment, crystal glasses may be used in combination with the device according to the invention in order to obtain a magnifying effect. In one embodiment of the invention, the mirrors are mounted separately on two separate stands. Instead of having the same locking member, locking the angular position of both mirrors in their vertical position, it is possible to have two separate locking members, wherein one locks the vertical position and the other locks the angular position.

1-18. (canceled)

19. A device to make it possible for a person to see an object located below his eyes, with his eyes directed substantially forward, comprising a first (1) and a second (2) mirror arranged such that they render an optical path reaching from the object towards a reflective surface (4) of the first mirror (1), then further to a reflective surface (5) of the second mirror (2), and then to the eyes, characterised in that the device comprises a framework (8; 40), and is designed to, at positioning of the framework and the mirrors in front of and at a distance from the body of a person having his upper part of his body substantially upright, holding his hands in a position in front of the upper part of his body, and having his eyes directed substantially forward, show the hands of the person, wherein the framework (8; 40) is arranged to hold the second mirror (2) at a farther distance from the person than the first mirror (1) at said positioning in front of the person.

20. A device as described in claim 19, characterised in that the mirrors (1, 2) are arranged vertically adjustable in relation to the framework (8; 40).

21. A device as described in claim 19, characterised in that each of the mirrors (1, 2) are arranged adjustable to different angular positions relative to the framework (8; 40) and thus relative to a person being in a fixed position.

22. A device as described in claim 19, characterised in that the mirrors (1, 2) are arranged such that the distance between them is adjustable.

23. A device as described in claim 19, characterised in that the mirrors (1, 2) are arranged vertically adjustable in relation to each other.

24. A device as described in claim 19, characterised in that it comprises a holding member (10; 42) arranged to hold the mirrors (1, 2) and that the holding member is arranged connected to the framework (8; 40).

25. A device as described in claim 24, characterised in that the holding member (10; 42) is arranged vertically adjustable relative to the framework.

26. A device as described in claim 25, characterised in that the framework (8; 40) shows longitudinal groove (11a, 11b) for the displacement movement and that the groove extends substantially vertically.

27. A device as described in claim 24, characterised in that the holding member (10) is arranged to be rotatable in relation to the framework (8) around an axis of rotation (14) and that the mirrors (1, 2) are arranged on opposite sides of said axis, such that when rotating in one direction around said axis, the first mirror (1) is raised as the second mirror (2) is lowered, and when rotating in the other direction around said axis, the first mirror (1) is lowered as the second mirror (2) is raised, wherein the mirrors are vertically adjustable in relation to each other by rotating the holding member.

28. A device as described in claim 26, characterised in that said axis of rotation (14) for the holding member coincides with said groove (11a, 11b), wherein the axis of rotation is displaceable along the groove.

29. A device as described in claim 27, characterised in that it comprises a locking member (15) arranged to lock the axis of rotation (14) and thus to lock the angular position of the holding member (10) relative to the framework (8).

30. A device as described in claim 29, characterised in that said locking member (15) also is arranged to lock the vertical displacement of the holding member (10) and thus at the same time lock the position and the angular position of the holding member relative to the framework (8).

31. A device as described in claim 24, characterised in that the distance between the mirrors (1, 2) is adjustable by at least one of the mirrors being arranged displaceable in relation to the holding member (10).

32. A device as described in claim 31, characterised in that said at least one mirror (1, 2) is arranged rotatable in relation to the holding member (10) around an axis of rotation (17, 18).

33. A device as described in claim 32, characterised in that it comprises at least one locking element (22, 23) arranged to lock the angular position of the mirror relative to the holding member (10) and that the locking element also is arranged to lock the displacement of the mirror relative to the holding member and thus at the same time lock both the position and the angular position of the mirror relative to the holding member.

34. A device as described in claim 32, characterised in that the holding member (10) shows longitudinal grooves (20a-20d) for the displacement movement of the mirror relative to the holding member, wherein the axis of rotation (17, 18) of the mirror is displaceable along the groove.

35. A device as described in claim 24, characterised in that the mirrors (1, 2) are arranged detachable from the holding member (10).

36. A device as described in claim 19, characterised in that the first mirror (1) is a confrontation mirror arranged such that it is possible to see through the mirror.
